(19) United States
(12) Patent Application Publication
(10) Pub. No.: US 2026/0213185 A1
(43) Pub. Date: Jul. 23, 2026

(54) PROCESS FOR MAKING A PARTICULATE (OXY)HYDROXIDE OR OXIDE, PARTICULATE (OXY)HYDROXIDE OR OXIDE AND USE

(71) Applicant: BASF SE, Ludwigshafen am Rhein (DE)

(72) Inventors: Thorsten BEIERLING, Wolfenbuettel (DE); Joop Enno FRERICHS, Ludwigshafen am Rhein (DE); Zoltan BAAN, Helsinki (FI)

(21) Appl. No.: 19/144,079

(22) PCT Filed: Jan. 2, 2024
(86) PCT No.: PCT/EP24/50036

§ 371 Date: Jun. 27, 2025

(30) Foreign Application Priority Data
Jan. 11, 2023 (EP) 23151128.8

(51) Int. Cl. H01M 4/525; C01G 53/44; C01G 53/84; H01M 4/36

(52) U.S. Cl. CPC H01M 4/525; C01G 53/44; C01G 53/84; H01M 4/366; C01P 2002/52; C01P 2004/03; C01P 2004/80; C01P 2006/12; C01P 2006/14; C01P 2006/40

(57) ABSTRACT

Disclosed herein are a process for making a particulate (oxy)hydroxide or oxide, a particulate (oxy)hydroxide or oxide, and a method of using the particulate (oxy)hydroxide or oxide.

Also disclosed herein is a process for making a particulate (oxy)hydroxide or oxide of TM where TM represents metals, where the process is performed in a cascade of at least three stirred tank reactors.

The present invention is directed towards a process for making a particulate (oxy)hydroxide or oxide of TM wherein TM represents metals, wherein TM comprises nickel and at least one metal selected from cobalt and manganese and wherein the nickel content of TM is at least 80 mol-%, wherein said process is performed in a cascade of at least three stirred tank reactors and comprises the steps of:
(a) providing an aqueous solution (α1) containing a water-soluble salt of Ni and, optionally, at least one transition metal other than nickel, and an aqueous solution (β1) containing an alkali metal hydroxide and, optionally, an aqueous solution (γ1) containing a complexing agent selected from ammonia, glycine, tartrate, citrate, and oxalate,
(b) combining, in a first stirred tank reactor, solution (α1) and solution (β1) and, if applicable, solution (γ1), at a pH value in the range of from 11.0 to 13.5, thereby creating slurried solid particles of a hydroxide of TM,
(c) transferring the particles from step (b) as a slurry into a second stirred tank reactor,
(d) providing an aqueous solution (α2) containing a water-soluble salt of Ni and of at least one metal selected from Co and Mn and, optionally, at least one transition metal other than nickel, and an aqueous solution (β2) containing an alkali metal hydroxide and, optionally, an aqueous solution (γ2) containing a complexing agent selected from ammonia, glycine, tartrate, citrate, and oxalate,
(e) combining solution (α2) and solution (β2) and, if applicable, solution (γ2), in said second stirred tank reactor at a pH value in the range of from 10.5 to 12.0 and with an average specific energy input in the range of from 2 to 8 W/l and by a factor of from 0.20 to 0.75 lower than in step (b), thereby growing the solid particles of a hydroxide of TM,
(f) transferring the particles from step (e) as a slurry into a third reactor that is a stirred tank reactor,
(g) combining solution (α2) and solution (β2) and, if applicable, solution (γ2), in said third stirred tank reactor at a pH value in the range of from 10.5 to 12.0,
wherein the average specific energy input in step (g) is in the range of from 0.5 to 2 W/l and by a factor of from 0.20 to 0.75 lower than in step (e), and wherein the pH values are determined at 23° C.

Lithiated transition metal oxides are currently being used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals preferably as hydroxides that may or may not be basic, for example oxyhydroxides. Hydroxides may be pre-calcined and turned into oxides or oxyhydroxides, or they are directly mixed with a source of lithium such as, but not limited to LiOH, Li₂O, Li₂O₂ or Li₂CO₃ and calcined (fired) at high temperatures. The source of lithium can be employed as hydrate(s) or in dehydrated form. The calcination—or firing—often also referred to as thermal treatment or heat treatment of the precursor—is usually carried out at temperatures in the range of from 600 to 1,000° C. During the thermal treatment a solid-state reaction takes place, and the electrode active material is formed. The thermal treatment is performed in the heating zone of an oven or kiln.

A typical class of cathode active materials delivering high energy density contains a high amount of Ni (Ni-rich), for example at least 80 mol-%, referring to the content of non-lithium metals. However, the energy density still needs improvement.

To a major extent, properties of the precursor translate into properties of the respective electrode active material, such as particle size distribution, content of the respective transition metals and more. It is therefore possible to influence the properties of electrode active materials by steering the properties of the precursor.

It has been found desirable to make precursors with a narrow particle size distribution, see, e.g., EP 2 720 305 A. It is furthermore desired to provide precursors of high sphericity.

In CN 112591807 A, a multi-stage co-precipitation process is disclosed that yields high-density precursors.

It was an objective of the present invention to provide a process by which precursors of cathode active materials with a high porosity, a narrow particle size distribution, a low tendency of agglomerate formation and a high reactor efficiency can be made. It was further an objective to provide a precursor for cathode active materials that has a narrow particle size distribution and a low tendency of agglomerate formation.

It has been found that precursors that serve as a starting material for cathode active materials with a high volumetric energy density can be obtained by avoiding particle agglomeration during the start-up of seeding batch growth stages. Without wishing to be bound by any theory, we assume that a high solid content helps to efficiently avoid unwanted agglomeration. A conventional two-stage process does not allow to start with sufficiently high solid contents because in this case the final batch solid content would be unfavorably high.

Accordingly, the process as set out at the outset was found, hereinafter also referred to as inventive process. The inventive process is a process for making a particulate oxyhydroxide or oxide of TM. Said particulate oxyhydroxide or oxide then serves as a precursor for electrode active materials, and it may therefore also be referred to as precursor. The inventive process comprises the following steps (a) and (b) and (c) and (d) and (e) and (f) and (g), hereinafter also referred to as step (a) and step (b) and step (c) and step (d) and step (e) and step (f) and step (g), or briefly as (a) or (b) or (c) or (d) or (e) or (f) or (g), respectively. The inventive process will be described in more detail below.

The resultant (oxy)hydroxide or oxide of TM is in particulate form. The particles size distribution may be determined by light scattering or LASER diffraction or electroacoustic spectroscopy, LASER diffraction being preferred. The particle size distribution may be characterized by the scan, (D90−D10) divided by D50, D50 being the median value. Preferably, the span of the resultant (oxy)hydroxide is below 0.3, more preferably from 0.10 to 0.28, more preferably 0.15 to 0.25.

In one embodiment of the present invention, the particle shape of the secondary particles of the resultant precursors is spheroidal, that are particles that have a spherical shape. Spherical spheroidal shall include not just those which are exactly spherical but also those particles in which the maximum and minimum diameter of at least 90% (number average) of a representative sample differ by not more than 10%.

In one embodiment of the present invention, the resultant precursors are comprised of secondary particles that are agglomerates of primary particles.

In one embodiment of the present invention the specific surface (BET) of the resultant precursors is in the range of from 2 to 120 m²/g, determined by nitrogen adsorption, for example in accordance with to DIN-ISO 9277:2003-05.

The precursor is an (oxy)hydroxide of TM wherein TM comprises Ni and, optionally, at least one transition metal selected from Co and Mn, and, optionally, at least one further metal selected from Ti, Zr, Mo, W, Al, Mg, Nb, Sb, and Ta. Preferably, the precursor comprises nickel and at least one metal selected from Co and Mn, more preferably, said precursor comprise nickel and cobalt and manganese.

Oxides of TM may contain residual hydroxyl groups or carbonate groups, for example in the range of from 100 to 1,000 ppm (by mass), determined by differential thermogravimetric methods (“DSC”) as weight loss at a temperature in the range of from 180 to 450° C.

In one embodiment of the present invention, TM is a combination of metals according to general formula (I)

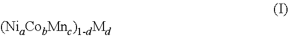

with
a being in the range of from 0.80 to 0.97, preferably from 0.83 to 0.95,
b being zero or in the range of from 0.025 to 0.2, preferably from 0.025 to 0.15,
c being in the range of from zero to 0.2, preferably from zero to 0.15, or from 0.01 to 0.15, and
d being in the range of from zero to 0.1, preferably from zero to 0.05,
M is selected from Ti, Zr, Mo, W, Al, Mg, Nb, Sb, and Ta,

$$a + b + c = 1 .$$

Preferably, d=zero.

TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

Step (a) includes providing an aqueous solution (α1) containing water-soluble salts of Ni and, optionally, of at least one metal selected from Co and Mn, and, optionally, at least one further metal selected from Ti, Zr, Mo, W, Al, Mg, Nb, Sb, and Ta, and an aqueous solution (β1) containing an alkali metal hydroxide and, optionally, an aqueous solution (γ1) containing a complexing agent selected from ammonia, glycine, tartrate, citrate, and oxalate.

The term “water-soluble salts” refers to salts that exhibit a solubility in distilled water at 25° C. of 25 g/l or more, the amount of salt being determined under omission of crystal water and of water stemming from aquo complexes. Water-soluble salts of nickel and cobalt and manganese may preferably be the respective water-soluble salts of Ni²⁺ and Co²⁺ and Mn²⁺. Examples of water-soluble salts of nickel and cobalt and manganese are the sulfates, the nitrates, the acetates and the halides, especially the chlorides. Preferred are nitrates and sulfates, of which the sulfates are more preferred.

Said aqueous solution (α1) preferably contains Ni and further metal(s) in the relative concentration that is intended as TM of the precursor, or in one of the fractions of the precursor. Preferably, solution (α1) contains salts of nickel and cobalt and manganese.

Said aqueous solution (α1) preferably contains Ni and, optionally, further metal(s) in a total concentration of from 0.5 to 2.2 mol/l.

Solution (α1) may have a pH value in the range of from 2 to 5. In embodiments wherein higher pH values are desired, ammonia may be added to solution (α1). In other embodiments, no ammonia is added to solution (α1).

In step (a), in addition an aqueous solution of alkali metal hydroxide is provided, hereinafter also referred to as solution (β1). An example of an alkali metal hydroxides is caesium hydroxide, preferred is potassium hydroxide and a combination of sodium and potassium hydroxide, and even more preferred is sodium hydroxide.

In embodiments wherein solution (β1) contains alkali metal hydroxide, said solution (β1) may additionally contain some amount of carbonate, e.g., 0.1 to 2% by weight, referring to the respective amount of alkali metal hydroxide, added deliberately or by aging of the solution or the respective alkali metal hydroxide.

Solution (β1) may have a concentration of alkali metal hydroxide in the range from 0.1 to 12 mol/, preferably 6 to 10 mol/l.

The pH value of solution (β1) is preferably 13 or higher, for example 14.5. In the context of the present invention, pH values are determined at 23° C. unless specifically noted otherwise.

In the inventive process, it is preferred to use ammonia. Solution (β1)—if applicable—contains a complexing agent selected from ammonia, glycine, tartrate, citrate, and oxalate. In the context of the present invention, the term glycine includes the compound glycine and its alkali metal salts, for example the potassium or preferably the sodium salt. The terms tartrate and oxalate include the respective free acids and the mono- and dialkali metal salts, for example the mono- or di-potassium salts or the mono- or disodium salts or mixed sodium and potassium salts. The term “citrate” includes citric acid and its alkali metal salts, for example the mono- or di- or trisodium salts and the mono-, di- and tripotassium salts.

In one embodiment of the present invention, solution (γ1) has an ammonia concentration in the range of from 1 to 30% by weight.

In one embodiment of the present invention, solution (γ1) contains in the range of from 0.05 to 1.0 mol-%, referring to TM, of a complexing agent selected from glycine, tartrate, citrate, and oxalate, or their respective alkali metal salts.

Step (b) includes combining solution (α1) and solution (β1) and, if applicable, solution (γ1), at a pH value in the range of from 11.0 to 13.5, preferably 11.2 to 12.5, thereby creating particles of a hydroxide of TM. Said particles are slurried in an aqueous medium. Again, pH values are determined at 23° C. unless specifically noted otherwise.

In one embodiment of the present invention, step (b) is performed at a temperature in the range from 10 to 85° C., preferably at temperatures in the range from 40 to 65° C.

In one embodiment of the present invention, step (b) is performed at a pressure in the range of from 500 mbar to 10 bar, preferably at ambient pressure.

In one embodiment of the present invention, an average specific energy of from 8 to 20 W/l, preferably from 9 to 17 W/l is introduced into the slurry, for example with a pitch-blade turbine, preferably with a Rushton turbine or with a combination of a pitch-blade turbine and a Rushton turbine. Stirrers may be one-stage or two-stage or multiple stage, for example three-stage or four-stage, two-stage and three-stage being preferred.

The energy introduction may be held constant during step (b) or be varied.

In one embodiment of the present invention, step (b) is performed in a continuous stirred tank reactor (“CSTR”). A CSTR is usually equipped with an overflow. In step (b), preferably a slurry with particles with an average diameter (D50) in the range of from 3 to 5 μm are removed and fed to a second stirred tank reactor. Performing step (b) in a batch reactor is preferred.

In on embodiment of the present invention, the solids content of slurry removed from step (b) is in the range of from 100 to 800 g/l. The solids content is determined by dissolving the precipitate in sulfuric acid and determining the metal content by IC (Inductively Coupled Plasma).

In one embodiment of the present invention, step (b) is performed in a continuous stirred tank reactor operated with an average residence time in the range of from 5 to 15 hours, preferably from 7 hours to 12 hours. In embodiments wherein step (b) is performed in a batch reactor, a average residence time of 15 to 60 hours is preferred. In embodiments wherein step (b) is performed in a batch reactor, a average residence time of 15 to 60 hours is preferred. In embodiments of step (b) with varying flow rates due to, e.g., varying feed rates of solution(s) (α2) and solution (β2) and, if applicable, solution (γ2), a temporary residence time may be calculated. Usually, in embodiments with strongly varying flow rates of at least one of solution(s) (α2) and solution (β2) and, if applicable, solution (γ2), the average residence time corresponds neither to the maximum nor the minimum residence time.

In step (c), particles from step (b) are transferred as a slurry into a second stirred tank reactor. The second stirred tank reactor is preferably operated as a batch reactor. In order to deal with a continuous supply of slurry from step (b) it is preferred to have to or more tank reactors for step (e) that may be operated in parallel.

Step (d) includes providing aqueous solution (α2) containing water-soluble salts of Ni and of at least one transition metal selected from Co and Mn, and, optionally, at least one further metal selected from Ti, Zr, Mo, W, Al, Mg, Nb, Sb, and Ta, and an aqueous solution (β2) containing an alkali metal hydroxide and, optionally, an aqueous solution (γ2) containing ammonia.

In the context of the present invention, the term “a solution contains a metal” shall mean that such solution contains a salt of said metal.

Said aqueous solution (α2) preferably contains Ni and further metal(s) in the relative concentration that is intended as TM of the precursor, or in one of the fractions of the precursor.

Solution (α2) may have the same composition as solution (α1) or a different one.

Said aqueous solution (α2) preferably contains Ni and, optionally, further metal(s) in a total concentration of from 0.1 to 12 mol/l, preferably 6 to 10 mol/l.

Solution (α2) may have a pH value in the range of from 2 to 5. In embodiments wherein higher pH values are desired, ammonia may be added to solution (α2).

Said aqueous solution (α2) preferably contains Ni and, optionally, further metal(s) in a total concentration of from 0.5 to 2.2 mol/l.

In step (a), in addition an aqueous solution of alkali metal hydroxide is provided, hereinafter also referred to as solution (β2). Solution (β2) may have a concentration of alkali metal hydroxide in the range from 0.1 to 12 mol/l, preferably 6 to 10 mol/l.

The pH value of solution (β2) is preferably 13 or higher, for example 14.5.

In the inventive process, it is possible to use ammonia but to feed it separately as solution (γ2) or in solution (β2) or in solution (α2).

Solution (β2) may have the same composition as solution (β1) or a different one, preferably the same.

Solution (γ2) may have the same composition as solution (γ1) or a different one, preferably the same.

In one embodiment of the present invention, solution (γ2) has an ammonia concentration in the range of from 1 to 30% by weight.

In one embodiment of the present invention, solution (γ2) contains in the range of from 0.05 to 1.0 mol-%, referring to TM, of a complexing agent selected from glycine, tartrate, citrate, and oxalate, or their respective alkali metal salts.

Step (e) includes combining solution (α2) and solution (β2) and, if applicable, solution (γ2), at a pH value in the range of from 10.5 to 12.0, preferably at a pH value lower than in step (b), for example by at least 0.5 units, preferably 11 to 12.5, thereby growing particles of a hydroxide of TM. Said particles are slurried in aqueous medium.

In one embodiment of the present invention, step (e) is performed at a temperature in the range from 10 to 85° C., preferably from 40 to 65° C. Steps (b) and (e) may be performed at different temperatures or preferably at the same.

In one embodiment of the present invention, step (e) is performed at a pressure in the range of from 500 mbar to 10 bar, preferably at ambient pressure.

In step (e), an average specific energy input of from 2 to 8 W/l, preferably from 2 to 7 W/l is introduced into the slurry in step (e), and the energy input is by a factor of 0.20 to 0.75 less than in step (b), for example with a stirrer as used in step (b). The average specific energy input may be constant over the time of step (e) or variable. In case the average specific energy input is not constant, the above value refers to the average value.

In one embodiment of the present invention, the average particle diameter of (oxy)hydroxide made in step (e) is in the range of from 6.5 to 9.5 μm but in any case bigger than at the end of step (b) and in step (c).

In one embodiment of the present invention, the solids content at the beginning of step (e) is in the range of from 20 to 60 g/l. If slurry obtained from step (b) and in step (c) has a higher concentration and the slurry thus a higher solids content, step (e) starts with diluting said slurry with an aqueous medium such as water, for example by charging the respective tank reactor with an aqueous medium such as water, diluted ammonia or the like.

In one embodiment of the present invention, the solids content at the end of step (e) is in the range of from 200 to 800 g/l.

In one embodiment of the present invention, step (e) has a duration in the range of from 7 to 45, preferably 15 to 40 hours but in any way shorter than step (b).

One or more feed rates of solutions (α2), (β2), and (γ2) in step (e) may be constant or vary, they may, for example, increase or decrease or oscillate. In case the feed rates are constant, the average residence time is identical to the residence time.

In embodiments of step (e) with varying flow rates due to, e.g., varying feed rates of solution(s) (α2) and solution (β2) and, if applicable, solution (γ2), a temporary residence time may be calculated. Usually, in embodiments with strongly varying flow rates of at least one of solution(s) (α2) and solution (β2) and, if applicable, solution (γ2), the average residence time corresponds neither to the maximum nor the minimum residence time.

Step (f) includes transferring the particles from step (e) as a slurry into a third reactor that is a stirred tank reactor, preferably a batch reactor, for example a draft-tube reactor. Draft tube reactors are known per se, e.g., T. Kumaresan et al., Hydrometallurgy 2014, 150, page 107 ff.

Step (g) includes combining solution (α2) and solution (β2) and, if applicable, solution (γ2), in said third stirred tank reactor at a pH value in the range of from 10.5 to 12.0, wherein the average specific energy input in step (g) is lower than in step (e). Solutions (α2), (β2) and (γ2) in step (g) may have the same composition as in step (e) or different, preferably, they have the same composition.

At the beginning of step (g), the solids content in the third stirred tank reactor is comparably low, for example 60 to 180 g/l. If slurry obtained from step (e) has a higher concentration and the slurry thus a higher solids content, step (g) starts with diluting said slurry with an aqueous medium such as water, for example by charging the respective tank reactor with an aqueous medium such as water, diluted ammonia or the like.

At the end of step (g), the solids content is higher, for example from 200 to 800 g/l.

In one embodiment of the present invention, an average specific energy input of from 0.2 to 2 W/l, preferably from 0.2 to 1.9 W/l is introduced into the slurry in step (g), and by a factor of from 0.20 to 0.75 less energy than in step (e), for example with a pitch-blade turbine, a propeller stirrer or a hydrofoil. The specific energy input may be constant over the time of step (g) or variable. In case the specific energy input is not constant, the above value refers to the average value.

In one embodiment of the present invention, step (g) is performed at a temperature in the range from 10 to 85° C., preferably from 40 to 65° C. Steps (g) and (e) may be performed at different temperatures or preferably at the same.

In one embodiment of the present invention, step (g) is performed at a pressure in the range of from 500 mbar to 10 bar, preferably at ambient pressure.

In one embodiment of the present invention, step (g) has a duration in the range of from 2 to 7 hours but in any way shorter than step (e).

One or more feed rates of solutions (α2), (β2), and (γ2) in step (g) may be constant or vary, they may, for example, increase or decrease or oscillate. In case the feed rates are constant, the average residence time is identical to the residence time.

In one embodiment of the present invention, the tank reactors in steps (b), (e) and (g) have different volumes. In another embodiment, the sizes and volumes of tank reactors in steps (b), (e) and (g) are the same.

In one embodiment of the present invention, step (g) is performed in a draft-tube reactor. Draft tubes are comparable with tubes that are inside the vessel body of the tank reactor and whose upper rim or at least one opening is below the gauge of the slurry in the tank reactor. Thus, slurry circulates through such draft tube. The stirrer element is then located in the draft tube.

In one embodiment of the present invention, in steps (b), (e) and (g), mother liquor is withdrawn from the reactors, for example by means of a clarifier, for example a lamellar clarifier, a candle filter or a thickener. Said mother liquor may contain solid particles of precursor, for example from 2 mg/l to 20 g/l, or may be free from solid particles for the naked eye.

In one embodiment of the present invention, slurry from steps (b) and (e) are transferred into a buffer vessel before subjecting them to the next co-precipitation steps.

In one embodiment of the present invention, the average particle diameter of (oxy)hydroxide made in step (g) is in the range of from 9.5 to 18 μm but in any case bigger than at the end of step (e).

In one embodiment of the present invention, the inventive process comprises the additional step (h) of separating particulate oxy(hydroxide by a solid-liquid separation method and subsequent drying.

By performing the inventive process, an aqueous slurry is formed. From said aqueous slurry, a particulate mixed hydroxide may be obtained by performing one or more solid-liquid separation steps, for example filtering or centrifuge. Additional work-up measures may be taken such as washing, e.g., with water or ammonia or NaOH solution, dehydration, drying under inert gas or air, or the like. If dried under air, a partial oxidation may take place, and a mixed oxyhydroxide of TM is obtained. Drying may be performed at a temperature in the range of from 100 to 150° C.

In one embodiment of the present invention, the inventive process comprises a heating step (i) at a temperature in the range of from 400 to 550° C. in the absence of a lithium compound. By step (i), the precursor is converted into an oxide of TM. Step (i) may be performed in a rotary kiln, in a fluidized bed, or in a roller hearth kiln.

In one embodiment of the present invention, step (i) is performed under an atmosphere of air, of oxygen-enriched air, or of pure oxygen.

In one embodiment of the present invention, step (i) has a duration in the range of from 1 hour to 12 hours.

Precursors obtained according to the inventive process are excellent starting materials for cathode active materials which are suitable for producing batteries with a high volumetric energy density. The volumetric density is dependent of the press density and the discharge capacity of a given cathode active material.

A further aspect of the present invention is related to precursors, hereinafter also referred to as inventive precursors. In one embodiment of the present invention, inventive precursors are particulate (oxy)hydroxides of TM with a span of the particle diameter distribution (D90−D10)/D50 below 0.30, wherein TM comprises nickel and at least one metal selected from cobalt and manganese, and wherein the secondary particles of inventive precursors are composed of primary particles. The secondary particles have a core and a shell and a concentric porous layer with a density higher than the density of the core and of the shell. Said concentric layer is visible from scanning electron microscopy (“SEM”) pictures. The average pore volume of inventive precursors that are (oxy)hydroxides is in the range of from 0.033 to 0.1 ml/g, determined by nitrogen adsorption. Preferably, the thickness of the medium layer may be in the range of from 0.5 to 6.0 μm, and the diameter of the core is in the range of from 2.0 to 6.0 μm.

Another embodiment of inventive precursors are particulate oxides of TM with a span of the particle diameter distribution (D90−D10)/D50 below 0.30, for example 0.20 to 0.29, wherein TM comprises nickel and at least one metal selected from cobalt and manganese, and wherein the particles are composed of primary particles. The average pore volume is in the range of from 0.1 to 0.5 ml/g, preferably 0.12 to 0.3 ml/g, determined by nitrogen adsorption.

The span in each case refers to the secondary particles. The secondary particles are agglomerated from primary particles that are essentially radially oriented.

The span of inventive precursors is below 0.30, for example in the range of from 0.10 to 0.28, preferably 0.18 to 0.26. The percentiles of D10, D90 and the median value are preferably determined by light scattering or LASER diffraction or electroacoustic spectroscopy, LASER diffraction being preferred.

TM is defined as outlined above.

Inventive particulate (oxy)hydroxide of TM has a total pore/intrusion volume in the range of from 0.033 to 0.1 ml/g, preferably 0.035 to 0.07 ml/g in the pore size range from 20 to 600 Å, determined by N₂ adsorption, determined in accordance with DIN 66134 (1998), when the sample preparation for the N₂ adsorption measurement is done by degassing at 120° C. for 60 minutes.

In a preferred embodiment, the average pore size of the inventive particulate transition metal (oxy)hydroxide is in the range of from 50 to 250 Å, determined by N₂ adsorption.

In one embodiment of the present invention, inventive particulate transition metal (oxy)hydroxide has an average secondary particle diameter D50 in the range of from 2 to 20 μm, preferably 2 to 16 μm and even more preferably 10 to 16 μm.

In one embodiment of the present invention, TM is a combination of metals according to general formula (I)

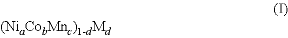

with
a being in the range of from 0.80 to 0.97, preferably from 0.83 to 0.95,
b being zero or in the range of from 0.025 to 0.2, preferably from 0.025 to 0.15,
c being in the range of from zero to 0.2, preferably from zero to 0.15, or from 0.01 to 0.15, and
d being in the range of from zero to 0.1, preferably from zero to 0.05,
M is selected from Ti, Zr, Mo, W, Al, Mg, Nb, Sb, and Ta,

$$a + b + c = 1 .$$

TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

Inventive precursors may contain some carbonate. Carbonate may have been incorporated inadvertently, for example from carbonate of alkali metal hydroxide, or by absorption of CO₂ when exposed to air. Inventive precursors may as well contain some counterion from a water-soluble salt that has served as source of, e.g., nickel during the precursor manufacture. Such counterion is preferably sulfate. The amounts of impurities such as carbonate and counterion from the source of nickel and further metal(s) preferably does not exceed 1% by weight of the inventive precursors.

In one embodiment of the present invention, inventive precursors have a specific surface according to BET (hereinafter also “BET-Surface”) in the range of from 2 to 120 m²/g, preferably from 4 to 50 m²/g. The BET surface may be determined by nitrogen adsorption after outgassing of the sample at 200° C. for 30 minutes or more and beyond this accordance with DIN ISO 9277:2010.

As outlined before, the secondary particles are agglomerated from primary particles that are essentially radially oriented.

Furthermore, at least 60% of the secondary particle volume is filled with radially oriented primary particles. Preferably, only a minor inner part, for example at most 40%, preferably at most 20%, of the volume of those particles is filled with non-radially oriented primary particles, for example, in random orientation.

Inventive oxide precursors have a total pore/intrusion volume in the range of from 0.1 to 0.5 ml/g, preferably 0.12 to 0.3 ml/cm³ in the pore size range from 20 to 600 Å, determined by N₂ adsorption, determined in accordance with DIN 66134 (1998), when the sample preparation for the N₂ adsorption measurement is done by degassing at 120° C. for 60 minutes.

In a preferred embodiment, the average pore size of inventive oxide precursors is in the range of from 30 to 500 Å, preferably 50 to 200 Å, determined by N₂ adsorption.

In one embodiment of the present invention, inventive precursor has an average secondary particle diameter D50 in the range of from 2 to 20 μm, preferably 2 to 16 μm and even more preferably 10 to 16 μm.

In one embodiment of the present invention, in inventive (oxy)hydroxide of TM
at least 60 vol.-% of the secondary particles consist of primary particles that are radially oriented or display a maximum deviation to a perfectly radial orientation of 11 degrees, and
wherein said particulate precursor has a total pore/intrusion volume in the range of from 0.033 to 0.1 ml/g, determined by N₂ adsorption.

In one embodiment of the present invention, in inventive oxide of TM
at least 60 vol.-% of the secondary particles consist of primary particles that are radially oriented or display a maximum deviation to a perfectly radial orientation of 11 degrees, and
wherein said particulate oxide of TM has a total pore/intrusion volume in the range of from 0.1 to 0.5 ml/g, determined by N₂ adsorption.

Inventive precursors have an excellent spherical shape. They are almost perfectly spherical, the average form factor being 0.98 or more. The (average) form factor is determined as follows:

The form factor of individual particles is calculated from the perimeter and area determined from top view SEM images:

$$Form factor = ( 4 π \cdot area ) / {( perimeter )}^{2}$$

While a perfect sphere would possess a form factor of 1.0, any deviation from perfect sphericity leads to form factors<1.0.

To determine the average form factor, the form factor is first determined for at least 50 individual particles of a representative sample and then averaged. This is why it may be referred to as average form factor as well.

In one embodiment of the present invention, inventive precursors have a specific surface according to BET in the range of from 2 to 120 m²/g, determined in accordance with DIN after heating to 120° C.

Precursors obtained according to the inventive process are excellent starting materials for cathode active materials which are suitable for producing batteries with a high volumetric energy density and excellent cycling stability. Such cathode active materials are made by mixing with a source of lithium, e.g., Li₂O or LiOH or Li₂CO₃, each water-free or as hydrates, and calcination, for example at a temperature in the range of from 600 to 1000° C. A further aspect of the present invention is thus the use of inventive precursors for the manufacture of cathode active materials for lithium-ion batteries, and another aspect of the present invention is a process for the manufacture of cathode active material for lithium-ion batteries—hereinafter also referred to as inventive calcination—wherein said process comprises the steps of mixing an inventive precursor with a source of lithium and thermally treating said mixture at a temperature in the range of from 600 to 1000° C. Preferably, the ratio of inventive precursor and source of lithium in such process is selected that the molar ratio of Li and TM is in the range of from 0.95:1 to 1.2:1.

Said precursors lead to cathode active materials with an very good volumetric energy density. Without wishing to be bound by any theory, it may be assumed that the orientation of the primary crystals and the high sphericity lead to such advantageous properties.

Examples of inventive calcinations include heat treatment at a temperature in the range of from 600 to 900° C., preferably 650 to 850° C. The terms “treating thermally” and “heat treatment” are used interchangeably in the context of the present invention.

In one embodiment of the present invention, the mixture obtained for the inventive calcination is heated to 600 to 900° C. with a heating rate of 0.1 to 10° C./min.

In one embodiment of the present invention, the temperature is ramped up before reaching the desired temperature of from 600 to 900° C., preferably 650 to 800° C. For example, first the mixture obtained from step (d) is heated to a temperature to 350 to 550° C. and then held constant for a time of 10 min to 4 hours, and then it is raised to 650° C. up to 800° C. and then held at 650 to 800 for 10 minutes to 10 hours.

In one embodiment of the present invention, the inventive calcination is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, the inventive calcination is performed in an oxygen-containing atmosphere, for example in a nitrogen-air mixture, in a rare gas-oxygen mixture, in air, in oxygen or in oxygen-enriched air. In a preferred embodiment, the atmosphere in step (d) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen.

In one embodiment of the present invention, the inventive calcination is performed under a stream of gas, for example pure oxygen and oxygen-enriched air, for example in the range of from 3:1 to 10:1 oxygen:air by volume, determined at ambient temperature and ambient pressure. Such stream of gas may be termed a forced gas flow. Such stream of gas may have a specific flow rate in the range of from 0.5 to 15 m³/h-kg material according to general formula Li₁₊ₓTM₁₋ₓO₂. The volume is determined under normal conditions: 298 Kelvin and 1 atmosphere. Said stream of gas is useful for removal of gaseous cleavage products such as water and carbon dioxide.

In one embodiment of the present invention, the inventive calcination has a duration in the range of from one hour to 30 hours. Preferred are 10 to 24 hours. The time at a temperature above 600° C. is counted, heating and holding but the cooling time is neglected in this context.

A further aspect of the present invention relates to cathode active materials, hereinafter also referred to as inventive cathode active materials. Inventive cathode active materials may best be manufactured from inventive precursors.

Inventive cathode active materials have the general formula Li₁₊ₓTM₁₋ₓO₂ with x being in the range of from −0.01 to +0.05, preferably +0.01 to 0.04, and with a span of the particle diameter distribution (D90−D10)/D50 below 0.30, wherein TM comprises nickel and at least one metal selected from cobalt and manganese,
wherein said cathode active material have a total pore/intrusion volume in the range of from 0.0035 to 0.01 ml/g, determined by N₂ adsorption.

In one embodiment of the present invention, inventive cathode material have a second—outer—shell comprising at least one oxide compound of W or B, for example, B₂O₃, LiBO₂, Li₂WO₄, WO₃, or the like. The second—outer—shell may be continuous or have an island structure.

The above span refers to the secondary particles. The secondary particles are agglomerated from primary particles that are essentially radially oriented. In this context, essentially radial aligned means that the primary particles in a representative sample at most 10% of the primary particles show a deviation from ideally radial alignment of 11° or less, and includes particles that have a perfect radial alignment of their primary particles. The determination may be performed by analysis of SEM micrographs.

The span of inventive cathode active materials is below 0.30, for example in the range of from 0.10 to 0.28, preferably 0.18 to 0.26. The percentiles of D10, D90 and the median value are preferably determined by light scattering or LASER diffraction or electroacoustic spectroscopy, LASER diffraction being preferred.

Inventive cathode active material has a total pore/intrusion volume in the range of from 0.033 to 0.1 ml/g, preferably 0.035 to 0.09 ml/g in the pore size range from 20 to 600 Å, determined by N₂ adsorption, determined in accordance with DIN 66134 (1998), when the sample preparation for the N₂ adsorption measurement is done by degassing at 120° C. for 60 minutes.

In a preferred embodiment, the average pore size of the inventive cathode active material is in the range of from 50 to 250 Å, determined by N₂ adsorption.

In one embodiment of the present invention, inventive cathode active material has an average secondary particle diameter D50 in the range of from 2 to 20 μm, preferably 2 to 16 μm and even more preferably 10 to 16 μm.

In one embodiment of the present invention, TM is a combination of metals according to general formula (I)

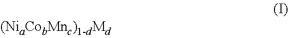

with
a being in the range of from 0.80 to 0.97, preferably from 0.83 to 0.95,
b being zero or in the range of from 0.025 to 0.2, preferably from 0.025 to 0.15,
c being in the range of from zero to 0.2, preferably from zero to 0.15, or from 0.01 to 0.15, and
d being in the range of from zero to 0.1, preferably from 0.03 to 0.05,
M is selected from Ti, Zr, Mo, W, Al, Mg, Nb, Sb, and Ta,

$$a + b + c = 1 .$$

Inventive cathode active materials are well suited for making lithium-ion batteries and especially cathodes for lithium-ion batteries.

A further aspect of the present invention refers to electrodes and specifically to cathodes, hereinafter also referred to as inventive cathodes. Inventive cathodes comprise
(A) at least one inventive cathode active material,
(B) carbon in electrically conductive form,
(C) at least one binder.

In a preferred embodiment of the present invention, inventive cathodes contain
(A) 80 to 99% by weight inventive cathode active material,
(B) 0.5 to 19.5% by weight of carbon,
(C) 0.5 to 9.5% by weight of binder polymer,
percentages referring to the sum of (A), (B) and (C).

Cathodes according to the present invention contain carbon in electrically conductive modification, in brief also referred to as carbon (B). Carbon (B) can be selected from soot, active carbon, carbon nanotubes, graphene, and graphite. Carbon (B) can be added as such during preparation of electrode materials according to the invention.

Electrodes according to the present invention can comprise further components. They can comprise a current collector (D), such as, but not limited to, an aluminum foil. They further comprise a binder polymer (C), hereinafter also referred to as binder (C). Current collector (D) is not further described here.

Suitable binders (C) are preferably selected from organic (co)polymers. Suitable (co)polymers, i.e., homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M_{w} in the range from 50,000 to 1,000,000 g/mol, preferably to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

A further aspect of the present invention is an electrochemical cell, containing
(A) a cathode comprising inventive cathode active material (A), carbon (B), and binder (C),
(B) an anode, and
(C) at least one electrolyte.

Embodiments of cathode (1) have been described above in detail.

Anode (2) may contain at least one anode active material, such as carbon (graphite), TiO₂, lithium titanium oxide, silicon or tin. Anode (2) may additionally contain a current collector, for example a metal foil such as a copper foil.

Electrolyte (3) may comprise at least one non-aqueous solvent, at least one electrolyte salt and, optionally, additives.

Non-aqueous solvents for electrolyte (3) can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and, in particular, 1,3-dioxolane.

Examples of suitable acyclic organic carbonates are dimethyl carbonate, ethyl methyl carbonate and diethyl carbonate.

Examples of suitable cyclic organic carbonates are compounds of the general formulae (II) and (III)

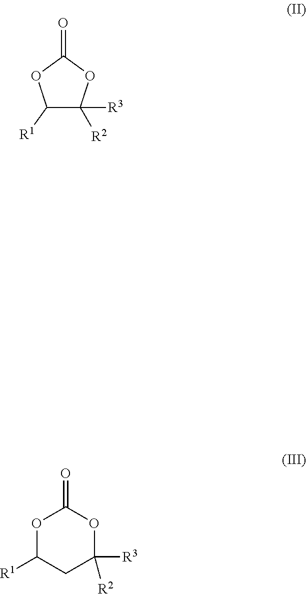

where R¹, R² and R³ can be identical or different and are selected from among hydrogen and C₁-C₄-alkyl, for example methyl, ethyl, n-propyl, isopropyl, n-butyl, isobutyl, sec-butyl and tertbutyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

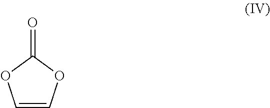

The solvent or solvents is/are preferably used in the water-free state, i.e. with a water content in the range from 1 ppm to 0.1% by weight, which can be determined, for example, by Karl-Fischer titration.

Electrolyte (3) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In a preferred embodiment of the present invention, electrolyte (3) contains at least one flame retardant. Useful flame retardants may be selected from trialkyl phosphates, said alkyl being different or identical, triaryl phosphates, alkyl dialkyl phosphonates, and halogenated trialkyl phosphates. Preferred are tri-C₁-C₄-alkyl phosphates, said C₁-C₄-alkyls being different or identical, tribenzyl phosphate, triphenyl phosphate, C₁-C₄-alkyl di-C₁-C₄-alkyl phosphonates, and fluorinated tri-C₁-C₄-alkyl phosphates,

In a preferred embodiment, electrolyte (3) comprises at least one flame retardant selected from trimethyl phosphate, CH₃—P(O)(OCH₃)₂, triphenylphosphate, and tris-(2,2,2-trifluoroethyl)phosphate.

Electrolyte (3) may contain 1 to 10% by weight of flame retardant, based on the total amount of electrolyte.

In an embodiment of the present invention, batteries according to the invention comprise one or more separators (4) by means of which the electrodes are mechanically separated. Suitable separators (4) are polymer films, in particular porous polymer films, which are unreactive toward metallic lithium. Particularly suitable materials for separators (4) are polyolefins, in particular film-forming porous polyethylene and film-forming porous polypropylene.

Separators (4) composed of polyolefin, in particular polyethylene or polypropylene, can have a porosity in the range from 35 to 50%. Suitable pore diameters are, for example, in the range from 30 to 500 nm.

In another embodiment of the present invention, separators (4) can be selected from among PET nonwovens filled with inorganic particles. Such separators can have a porosity in the range from 40 to 55%. Suitable pore diameters are, for example, in the range from 80 to 750 nm.

Batteries according to the invention can further comprise a housing which can have any shape, for example cuboidal or the shape of a cylindrical disk. In one variant, a metal foil configured as a pouch is used as housing.

Batteries according to the invention provide a very good discharge and cycling behavior, in particular at high temperatures (45° C. or higher, for example up to 60° C.) in particular with respect to the capacity loss.

Batteries according to the invention can comprise two or more electrochemical cells that combined with one another, for example can be connected in series or connected in parallel. Connection in series is preferred. In batteries according to the present invention, at least one of the electrochemical cells contains at least one electrode according to the invention. Preferably, in electrochemical cells according to the present invention, the majority of the electrochemical cells contain an electrode according to the present invention. Even more preferably, in batteries according to the present invention all the electrochemical cells contain electrodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The invention is further illustrated by working examples and drawings.

### General Remarks:

A cascade of three 3.2-liter stirred tank reactors made of glass and each equipped with baffles and a two-stage four-bladed pitch-blade turbine (45° angle, diameter: 0.06 m) was used for the experimental examples. Each stirred tank reactor was furthermore equipped with a settling device via which mother liquor was withdrawn from the reactors, and an overflow.

All pH values were determined at 23° C.
rpm: revolutions per minute
Total solids contents were determined by H₂SO₄ dissolution of an aliquot of the respective suspension and subsequent ICP analysis of Ni, Co, Mn

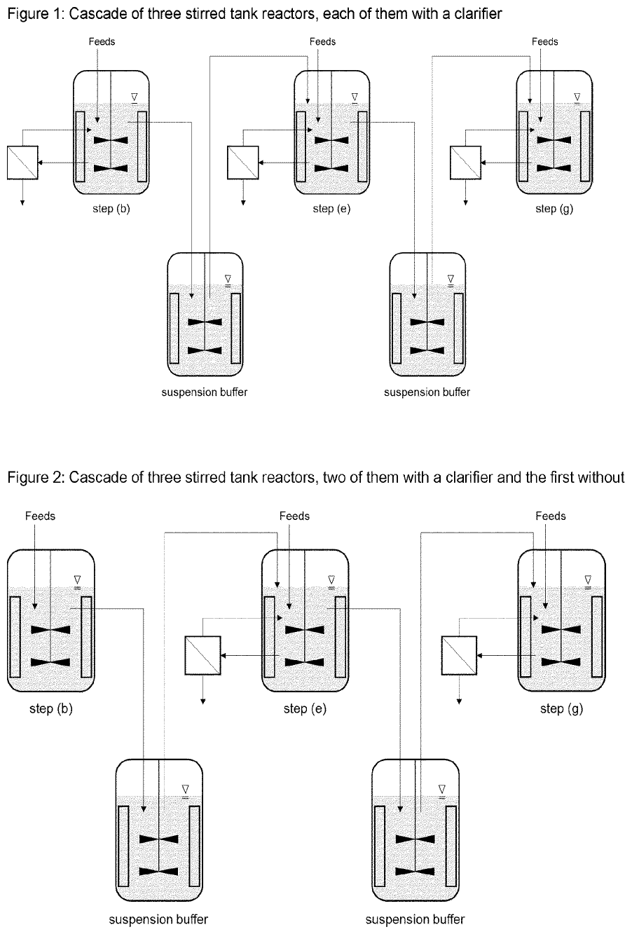

FIG. 1: cascade of three stirred tank reactors, each equipped with overflow systems, clarifiers, baffles, and with two buffer tanks

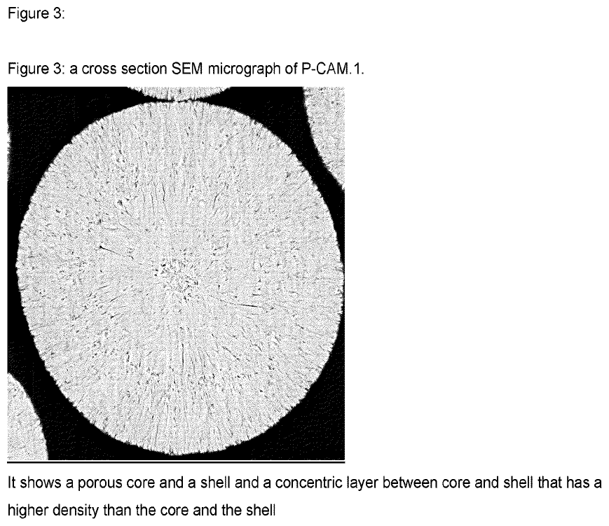

FIG. 2: cascade of three stirred tank reactors, each equipped with overflow systems, baffles, and with two buffer tanks. The second and the third stirred tank reactor are equipped with a clarifier, the first is not.

### I. Manufacture of Precursors

### I.1 Manufacture of Inventive (Oxy)Hydroxide P-CAM.1 and of Dehydrated Oxy-P-CAM.1

### Step (a.1):

The following aqueous solutions were provided:
Solution (α1.1): NiSO₄, CoSO₄ and MnSO₄ dissolved in deionized water, molar ratio 91:4.5:4.5, total transition metal concentration: 1.45 mol/kg
Solution (β1.1): 25 wt % NaOH dissolved in deionized water
Solution (γ1.1): 25 wt % ammonia in deionized water

Percentages refer to % by weight unless expressly noted otherwise.

### Prior to Step (b.1)

The first stirred tank reactor of the cascade was charged with 2.7 liters of deionized water and heated to 55° C. under stirring with 500 rpm (average specific energy input: 0.63 W/l). Afterwards 165 g of solution (γ.1) was added and the pH value was adjusted to 12.45 by adding solution (β.1).

### Step (b.1):

Subsequently, the stirrer speed was adjusted to 750 rpm (16 W/l) and the simultaneous feeding of solutions (α1.1), (β1.1) and (γ1.1) was started. The stirrer speed was kept constant during step (b.1). The total flow rate was adjusted in a way that the ratio between reactor volume (3.2 l) and total volume flow amounted to 10 hours (residence time equivalent). The temperature was remained constant at 45° C. The molar feed ratio between ammonia and TM was set to 0.25 and was kept constant during step (b.1). The pH value was adjusted to 11.5. Mother liquor was continuously withdrawn from the reaction system to increase the solid content. Step (b.1) had a duration of 47 h resulted in a slurry in the stirred tank reactor (excluding clarifier) with a solids content of 427 g/l.

All feed flows were stopped and the suspension from reactor and clarifier was discharged to a stirred suspension buffer vessel. The suspension contained slurried particles with an average particle size (d50) of 4.3 μm and with a span of 0.7.

### Step (c.1)

The second reactor of the cascade was charged with 2.6 l of de-ionized water and heated to 55° C. under stirring (500 rpm, specific energy input: 0.65 W/l). 83 g of solution (γ2.1) were added. Then, 530 g of the suspension from step (b.1) were added to the reactor. The solids content at the beginning of step (e.1) was 52 g/l.

### Step (d.1):

The following aqueous solutions were provided:
Solution (α2.1): NiSO₄, CoSO₄ and MnSO₄ dissolved in deionized water, molar ratio 91:4.5:4.5, total transition metal concentration: 1.45 mol/kg
Solution (β2.1): 25 wt % NaOH dissolved in deionized water
Solution (γ2.1): 25 wt % ammonia in deionized water

The respective solutions (α2.1), (β2.1) and (γ2.1) in step (g.1) had the same compositions.

### Step (e.1)

Subsequently, the simultaneous feeding of solutions (α2.1), (β2.1), and (γ2.1) was started. The molar feed ratio between ammonia and TM was set to 0.35 and was kept constant. The temperature was remained constant at 55° C. during step (e). The pH value was adjusted to 11.5 and then kept constant at this value until the end of step (e.1). The ratio between reactor volume (3.2 liter) and total volume flow of the feeds (residence time equivalent) was started with 33 hours and feeds were ramped-up during the synthesis to a residence time equivalent of five hours. The rotation speed of the stirrer was stepwise decreased during the batch to a final stirrer speed of 780 rpm (2.25 W/l). The stirrer profile was designed in a way that the average specific energy input was 3.7 W/l during step (e.1). Mother liquor was continuously withdrawn from the tank reactor to increase the solid content. The complete duration of step (e.1) was 20 hours and resulted in a slurry with a total solids content in the reactor of 304 g/l. After completion of the batch all feed flows were stopped and the resultant suspension from reactor and clarifier were discharged to a stirred suspension buffer vessel. The particles in said suspension had an average particle size (d50) of 7.3 μm and a span of 0.53.

### Step (f.1)

An amount of 2.3 liters of deionized water were added to the third stirred tank reactor of the cascade and heated to 55° C. under stirring with 500 rpm (0.68 W/L). Then, 83 g of solution (γ2.1) and 940 g suspension from step (e.1) were added to the tank reactor. The resultant slurry had an initial solid content of 76 g/L.

### Step (g.1)

The stirrer speed was adjusted to 800 rpm (1.9 W/l) and the simultaneous addition of solutions (α2.1), (β2.1), and (γ2.1) was started. The temperature was remained constant at 55° C. during step (g.1). The molar feed ratio between ammonia and TM was kept at 0.35 during step (g.1). The pH value was adjusted to 11.5 within the first hour and kept constant in step (g.1). The ratio between reactor volume (3.2 l) and total volume flow of the feeds (residence time equivalent) was started at 33 hours. Then, the feeds were ramped-up during step (g.1) to a final residence time equivalent of 5 hours. The feed profile was designed in a way that the average residence time was 5.8 hours. The rotation speed of the stirrer was step-wisely reduced during step (g.1) to a final stirrer speed of 550 rpm (0.7 W/l) so the average was 1.4 W/l. Mother liquor was continuously withdrawn through the clarifier to increase the solids content. The complete duration of step (g.1) was 21.2 hours. A slurry with a solids content of 347 g/l was obtained. All feed flows were stopped and the resultant suspension from reactor and clarifier was discharged to a stirred suspension buffer vessel.

### Work-Up:

The slurry from step (g.1) was filtered. The resulting filter cake was washed with deionized water and then with an aqueous solution of sodium hydroxide (1 kg of 25 wt % aqueous sodium hydroxide solution per kg of solid hydroxide).

The filter cake was dried at 120° C. over a period of 12 hours in a cabinet dryer to obtain mixed metal (oxy)hydroxide P-CAM.1. P-CAM.1 had an average particle diameter (D50) of 14.4 μm, a span of 0.23, and a BET surface area of 19.2 m²/g. The average form factor amounted to 0.991. The pore volume determined by N₂ adsorption was 0.048 ml/g.

### Oxy-P-CAM.1

Inventive P-CAM.1 was heated in a Linn oven for 2 hours at 450° C. under flowing air to obtain mixed metal oxide oxy-P-CAM.1. The inventive Oxy-P-CAM.1 had an average particle diameter (D50) of 14.3 μm, a span of 0.23 and BET surface area of 97.6 m²/g. The average form factor amounted 0.990. The pore volume determined by N₂ adsorption was 0.211 ml/g.

### I.2 Manufacture of a Comparative (Oxy)Hydroxide C-P-CAM.1 and of Comparative Dehydrated Oxy-C-P-CAM.1

Steps (a.1), (b.1), (c.1) and (d.1) were repeated.

### Step C-(e.2)

Subsequently, the simultaneous feeding of solutions (α2.1), (β2.1), and (γ2.1) was started. The molar feed ratio between ammonia and TM was set to 0.35 and was kept constant. The temperature was remained constant at 55° C. during step (g). The pH value was adjusted to 11.5 and then kept constant at this value until the end of step C-(e.2). The stirring speed was adjusted to 1200 rpm (6.3 W/l). The ratio between reactor volume (3.2 liter) and total volume flow of the feeds (residence time equivalent) was started with 33 hours and feeds were ramped-up during the synthesis to a residence time equivalent of 5 hours. The rotation speed of the stirrer was stepwise decreased during the batch to a final stirrer speed of 550 rpm (0.7 W/l). The stirrer profile was designed in a way that the average specific energy input was 2.4 W/l during step C-(e.2). Mother liquor was continuously withdrawn from the tank reactor to increase the solid content. The complete duration of step C-(e.2) was 20 hours and resulted in a slurry with a total solids content in the reactor of 304 g/l. After completion of the batch all feed flows were stopped and the final suspension from reactor and clarifier were discharged to a stirred suspension buffer vessel. The particles in the suspension had an average particle size (d50) of 14.3 μm with a span of 0.38.

Neither step (f) nor (g) was performed.

### Work-Up:

The slurry from step C-(e.2) was filtered. The resulting filter cake was washed with deionized water and then with an aqueous solution of sodium hydroxide (1 kg of 25 wt % aqueous sodium hydroxide solution per kg of solid hydroxide).

The filter cake was dried at 120° C. over a period of 12 hours in a cabinet dryer to obtain mixed metal (oxy)hydroxide C-P-CAM.2. C-P-CAM.2 had an average particle diameter (D50) of 14.2 μm, a span of 0.35, and a BET surface area of 21.2 m²/g. The average form factor amounted to 0.972. The pore volume determined by N₂ adsorption was 0.029 ml/g.

### Oxy-C-P-CAM.2

C-P-CAM.2 was heated in a Linn oven for 2 hours at 450° C. under flowing air to obtain mixed metal oxide Oxy-P-CAM.2. The comparative precursor Oxy-P-CAM.2 had an average particle diameter (D50) of 14.0 μm, a span of 0.35 and BET surface area of 95.5 m²/g. The average form factor amounted 0.971.

The pore volume determined by N₂ adsorption was 0.082 ml/g.

Table 1 summarizes the properties of the inventive and of the comparative precursors.

TABLE 1
inventive and comparative precursors

| | D50 | span | BET | Pore volume | Form |
|---|---|---|---|---|---|
| | [μm] | [—] | [m²/g] | [ml/g] | factor [—] |
| P-CAM.1 | 14.4 | 0.23 | 19.2 | 0.048 | 0.991 |
| C-P-CAM.2 | 14.2 | 0.35 | 21.2 | 0.029 | 0.972 |
| Oxy-P-CAM.1 | 14.3 | 0.23 | 97.6 | 0.211 | 0.990 |
| Oxy-C-P-CAM.2 | 14.0 | 0.35 | 95.6 | 0.082 | 0.971 |

### II. Manufacture of Inventive and Comparative Cathode Material

### II.1 Calcination and Post-Treatments of an Inventive Precursor

30 g of oxy-P-CAM.1 was mixed with LiOH monohydrate (molar ratio Li/metal=1.04), 133 mg TiO₂ and 122 mg ZrO₂ for 15 minutes in a grinding mill. A saggar was charged with the resultant mixture and transferred into a Linn oven. The temperature was raised at rate of 2 C/min to 750° C. under flowing oxygen and then held constant at 750° C. for 8 hours and subsequently allowed to naturally cool under flowing oxygen. The resultant powder was then deagglomerated in a grinding mill and sieved.

30 g powder was then added to 15 ml deionized water, stirred for 2 minutes and then immediately filtered on a Buchner funnel to remove water. The wet filter cake was then dried under an N₂ atmosphere with reduced pressure at 120° C. for 10 hours.

The resultant powder was then dry coated with boric acid by mixing 30 g powder, mixing media and 30 mg boric acid for 40 minutes at low speed on a roller mill. A saggar was charged with the dried powder and heat treated in Linn oven. The Linn oven was heated to 300° C. for 2 hours under oxygen atmosphere and allowed to cool naturally. Inventive CAM.1 was obtained with a (D50) of 14.3 μm, a span of 0.22 and an average form factor of 0.993. The pore volume of CAM.1 was 0.0044 ml/g.

### II.2 Manufacture of a Comparative Cathode Active Material

The comparative oxide Oxy-C-PCAM.2 was treated in the same way and C-CAM.2 was obtained with a (D50) of 14.0 μm, a span of 0.34 and an average form factor of 0.975. The pore volume of C-CAM.2 was 0.0031 ml/g.

### III. Testing of Cathode Active Material

### III.1 Cathode Manufacture

Positive electrode: PVDF binder (polyvinylidene difluoride, Solef® 5130) was dissolved in NMP (Merck) to produce a 7.5 wt. % solution. For electrode preparation, binder solution (3 wt. %), graphite (SFG6 L, 2 wt. %), and carbon black (Super C65, 1 wt.-%) were suspended in NMP. After mixing using a planetary centrifugal mixer (ARE-250, Thinky Corp., Japan), either inventive CAM.1 or C-CAM.2 (94 wt. %) was added and the suspension was stirred again to obtain a lump-free slurry. The solids content of the slurry was adjusted to 65%. The slurry was coated onto Al foil using a KTF-S roll-to-roll coater (Mathis AG). Prior to use, all electrodes were calendared. The thickness of cathode material was 70 μm, corresponding to 15 mg/cm². All electrodes were dried at 105° C. for 7 hours before battery assembly.

### III.2 Electrolyte Manufacture

A base electrolyte composition was prepared containing 12.7 wt % of LiPF₆, 26.2 wt % of ethylene carbonate (EC), and 61.1 wt % of ethyl methyl carbonate (EMC) (EL base 1), based on the total weight of EL base 1. To this base electrolyte formulation 2 wt. % of vinylene carbonate (VC) was added (EL base 2).

### III.3 Test Cell Manufacture—Coin Type Half Cells

Coin-type half cells (20 mm in diameter and 3.2 mm in thickness) comprising a cathode prepared as described under II.1.1 and lithium metal as working and counter electrode, respectively, were assembled and sealed in an Ar-filled glove box. In addition, the cathode and anode and a separator were superposed in order of cathode//separator//Li foil to produce a half coin cell. Thereafter, 0.15 mL of the EL base 1 which is described above (III.2) were introduced into the coin cell.

### III.4 Evaluation of Cell Performance

The initial performance, C-rate performance and cycling performance were measured as follows: Coin half cells according to 11.3 were tested in a voltage range between 4.3 V to 2.8 V at room temperature. For the initial cycles, the initial lithiation was conducted in the CC-CV mode, i.e., a constant current (CC) of 0.1 C was applied until reaching 4.3V, followed by the CV step until the current dropped to 0.01 C. After 10 min resting time, reductive lithiation was carried out at constant current of 0.1 C up to 2.8 V. For the C-rate test charge and discharge rates were adjusted accordingly. For the cycling test, the constant current was chosen to be 1C until 100 cycles were reached. The results are summarized in Table 2.

TABLE 2
Physical and electrochemical data of cathode active materials.
The pressed densities were determined at 250 MPa

| | | | pore | 1^{st} Dis- | 0.1 C rate | Press |
|---|---|---|---|---|---|---|
| | D50 | | volume | charge | capacity | density |
| | μm | span | ml/g | mAh/g | mAh/g | g/cm³ |
| CAM.1 | 14.3 | 0.22 | 0.0044 | 230.7 | 228.1 | 3.44 |
| CAM.C2 | 14.0 | 0.34 | 0.0031 | 227.2 | 225.3 | 3.31 |

1. A process for making a particulate (oxy)hydroxide or oxide of TM wherein TM represents metals, wherein TM comprises nickel and at least one metal selected from the group consisting of cobalt and manganese and wherein the nickel content of TM is at least 80 mol-%, wherein said process is performed in a cascade of at least three stirred tank reactors and comprises the steps of:
(a) providing an aqueous solution (α1) containing a water-soluble salt of Ni and, optionally, at least one metal selected from the group consisting of cobalt and manganese, and an aqueous solution (β1) containing an alkali metal hydroxide and, optionally, an aqueous solution (γ1) containing a complexing agent selected from the group consisting of ammonia, glycine, tartrate, citrate, and oxalate,
(b) combining, in a first stirred tank reactor, solution (α1) and solution (β1) and, if applicable, solution (γ1), at a pH value in the range of from 11.0 to 13.5 and with an average energy input in the range of from 8 to 20 W/l, thereby creating slurried solid particles of a hydroxide of TM,
(c) transferring the particles from step (b) as a slurry into a second stirred tank reactor,
(d) providing an aqueous solution (α2) containing a water-soluble salt of Ni and at least one metal selected from the group consisting of cobalt and manganese, and an aqueous solution (β2) containing an alkali metal hydroxide and, optionally, an aqueous solution (γ2) containing a complexing agent selected from the group consisting of ammonia, glycine, tartrate, citrate, and oxalate,
(e) combining solution (α2) and solution (β2) and, if applicable, solution (γ2), in said second stirred tank reactor at a pH value in the range of from 10.5 to 12.0 and with an average specific energy input in the range of from 2 to 8 W/l and by a factor of from 0.20 to 0.75 lower than in step (b), thereby growing the solid particles of a hydroxide of TM,
(f) transferring the particles from step (e) as a slurry into a third stirred tank reactor,
(g) combining solution (α2) and solution (β2) and, if applicable, solution (γ2), in said third stirred tank reactor at a pH value in the range of from 10.5 to 12.0,
wherein the average specific energy input in step (g) is in the range of from 0.5 to 2 W/l and by a factor of 0.20 to 0.75 lower than in step (e), and wherein the pH values are determined at 23° C.

2. The process according to claim 1, wherein the initial solid content at stage start increases from step (b) to step (e) to step (g).

3. The process according to claim 1, wherein the particulate (oxy)hydroxide is selected from the group consisting of hydroxides, oxyhydroxides and oxides of TM wherein TM is a combination of metals according to general formula (I) 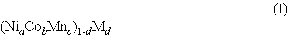
with
a being in the range of from 0.80 to 0.97,
b being zero or in the range of from 0.025 to 0.2,
c being in the range of from zero to 0.2, and
d being in the range of from zero to 0.1,
M is selected from the group consisting of Mg, Al, Ti, Zr, Mo, W, Nb, Sb, and Ta, and
a+b+c=1, and b+c>zero.

4. The process according to claim 1, wherein step (g) is performed in a draft-tube reactor.

5. The process according to claim 1, wherein in two of the steps (b), (e) and (g), mother liquor is withdrawn from the reactors.

6. The process according to claim 1, comprising the additional step (h) of separating particulate (oxy)hydroxide by a solid-liquid separation method and subsequent drying.

7. The process according to claim 6, wherein said process comprises a heating step (i) at a temperature in the range of from 400 to 550° C. in the absence of a lithium compound.

8. A particulate (oxy)hydroxide of TM with a core-shell structure and a span of the particle diameter distribution (D90−D10)/D50 below 0.30, wherein TM comprises nickel and at least one metal selected from the group consisting of cobalt and manganese and wherein the nickel content of TM is at least 80 mol-%, and wherein the particles are composed of primary particles and have a core and shell and a concentric layer between core and shell wherein the density of the concentric layer is higher than the density of the core and of the shell,
and wherein said particulate (oxy)hydroxide has a total pore/intrusion volume in the range of from 0.033 to 0.1 ml/g, determined by N₂ adsorption.

9. A particulate oxide of TM with a core-shell structure and a span of the particle diameter distribution (D90−D10)/D50 below 0.30, wherein TM comprises nickel and wherein the nickel content of TM is at least 80 mol %, and at least one metal selected from the group consisting of cobalt and manganese, and wherein the particles are composed of primary particles,
and wherein said particulate oxide has a total pore/intrusion volume in the range of from 0.1 to 0.5 ml/g, determined by N₂ adsorption.

10. The particulate (ox)hydroxide or oxide according to claim 8, having a specific surface according to BET in the range of from 2 to 120 m²/g.

11. The particulate (ox)hydroxide or oxide according to claim 8, having an average form factor of 0.98 or more.

12. The particulate (ox)hydroxide or oxide according to claim 8, wherein TM is a combination of metals according to general formula (I) 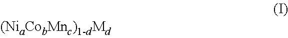
with
a being in the range of from 0.80 to 0.97,
b being zero or in the range of from 0.025 to 0.2,
c being in the range of from zero to 0.2, and
d being in the range of from zero to 0.1,
M is selected from the group consisting of Mg, Al, Ti, Zr, Mo, W, Nb, Sb, and Ta, and
a+b+c=1, and b+c>zero.

13. The process for the manufacture of cathode active materials for lithium-ion batteries comprising the steps of mixing a particulate (ox)hydroxide or oxide according to claim 8, with a source of lithium and, optionally, a dopant selected from the group consisting of an oxide and (oxy)hydroxide of Nb, Ti, Ta, Zr, Al, Mg, or W, and calcining the resultant mixture at a temperature in the range of from 600 to 1000° C.

14. A cathode active material of the general formula Li₁₊ₓTM₁₋ₓO₂ with x being in the range of from −0.01 to +0.05 and with a core-shell structure and a span of the particle diameter distribution (D90−D10)/D50 below 0.30, wherein TM comprises nickel and at least one metal selected from the group consisting of cobalt and manganese, wherein the nickel content of TM is at least 80 mol %,
wherein said cathode active material has a total pore/intrusion volume in the range of from 0.0035 to 0.01 ml/g, determined by N₂ adsorption.

15. The cathode active material according to claim 14, wherein said cathode material has a second—outer—shell comprising at least one oxide compound of W or B.
